(19) United States
(12) Patent Application Publication
(10) Pub. No.: US 2008/0217337 A1
(43) Pub. Date: Sep. 11, 2008

(54) Container with Tamperproof Seal

(75) Inventors: Stephane Rault, Paris (FR); Dominique Bois, Montreuil aux Lions (FR)

Correspondence Address: DENNISON, SCHULTZ & MACDONALD, 1727 KING STREET, SUITE 105, ALEXANDRIA, VA, 22314, US

(73) Assignee: AIRSEC, Choisy le Roi (FR)

(21) Appl. No.: 12/064,732

(22) PCT Filed: Sep. 21, 2006
(86) PCT No.: PCT/FR2006/002166

§ 371 Date: Mar. 19, 2008

(30) Foreign Application Priority Data
Sep. 21, 2005 (FR) 0509630
Jun. 13, 2006 (FR) 0605241

(51) Int. Cl. B65D 41/32; B65D 43/08; B65D 43/16; B23P 19/04

(52) U.S. Cl. 220/266; 220/796; 220/810; 29/700

(57) ABSTRACT

A container with tamper-evident device includes an open packaging casing, a closure means for closing this open end, a connection means arranged between the closure means and the casing, and a tamper-evident device which is able to engage mechanically at the time of closing the container after filling. The tamper-evident device includes a breakable locking means equipped with a snap-fastening means, positioned in a reserved housing, the locking means having an integral tear-open hinge, and a retaining means located in the closure means capable of receiving the snap-fastening means during the arming of the tamper-evident device.

### FIELD OF THE INVENTION

The invention relates to a container with tamper-evident device for packaging products in an optionally controlled atmosphere.

More specifically, the invention relates to a container comprising:

a casing constituting the packaging zone for products to be packaged, such as, for example, products of the pharmaceutical, cosmetic, food, veterinary, diagnostic or other type, regardless of their physical state, a closure means for closing the open end of the casing, such as a stopper/lid for example, which is connected to the casing by a hinge-type connection, said container having a tamper-evident device which is able to engage mechanically and deliberately at the time of definitive closure of the container after said container has been filled.

Thus, such a tamper-evident device can allow the closing and opening of the container without having been engaged as a tamper-evident device and can engage only when a decision has been made to do so, such as for example by the pharmaceutical laboratory after this packaging has been filled.

It no longer concerns a device for providing evidence that the container has been opened prior to the first opening of said container, if the latter has been closed again before its filling phase, but rather a device for providing evidence that the armed container has been opened, after it has been filled and placed on the market so as then to be opened by the user who must check the physical integrity of the protective packaging which guarantees the qualitative and quantitative authenticity of the product contained therein.

### PRIOR ART

Many tamper-evident devices which provide evidence of opening of containers are described in the technical literature, in particular in the literature consisting of patent applications and/or published patents.

Most containers comprising a packaging casing and a lid are effectively equipped, between said container and said lid, with a device which provides evidence of first opening. This device which provides evidence of first opening, or tamper-evident device, is formed for example of micro-connections which connect all or part of the lower peripheral surface of the lid to all or part of the upper peripheral surface of a ring or collar or else to any attachment system such as an annulus which fixes the lid to the body of the container or secured to the body of the container.

These micro-connections are micro-connection points which are independent of one another but form a perimeter or simple toothed connection zone between the movable lid and the ring or the collar or the system which fixes said lid to the body of the container.

These micro-points are broken at the time of first opening by the application of a breaking force which is exerted on the lid in the vertical direction, from the bottom upwards, if it is a simple connection via micro-points between the ring or collar secured to the container and lid, or else in the horizontal direction by a circular tearing motion if it is a double row of breaking points on an intermediate connecting collar between the container body and the lid. The first user carries out this gesture and thus knows that he is indeed the first user. He can also see whether the micro-point connection is or is not still present.

However, these tamper-evident devices do not make it possible to close the container, generally the empty container, at least a first time in order to subsequently open it for filling purposes, but without breaking the micro-connection points, since they do not have systems for arming the tamper-evident device.

On the contrary, the prior art describes containers or packagings, in particular pharmaceutical containers or packagings, which have a child-proof safety device that can be armed or else a tamper-evident device which can also be armed.

Thus:

One document (U.S. Pat. No. 4,809,874) describes a packaging, intended for medicaments or other dangerous products, equipped with a closure system which is difficult for a child to open and which comprises, in particular, a locking device with two positions which, in a first configuration, allows adults with limited dexterity to easily open the container and which, in another configuration, provides substantial resistance which prevents children from being able to open such a container. Furthermore, a hinged lid makes it possible to secure the closure means to the body of the container, even though these are moulded separately.

It therefore appears that this child-proof closure system indeed has two operating positions using a system of locking by means of a movable hook, mounted on a hinge, but it is not a tamper-evident device.

One document (U.S. Pat. No. 6,398,067) describes a container equipped with a tamper-evident device comprising a lid and a tubular casing. A detachable protrusion, located on the upper end of the tubular casing at an end piece, has a contact element which is a hook and a breaking point. The hinged lid has a skirt extending perpendicularly outside the lid and a rim of the tab type extending perpendicular to the skirt and towards the outside of said skirt. This rim comprises at least one housing which is able to house the detachable protrusion and a second housing of the opening type which participates in the locking process by the fact that the contact element, which is the hook, engages therein at the time of arming after filling. In an open state, this protrusion is positioned inside the first housing, whereas in a closed state the lid is placed on the body of the container and the protrusion is repositioned inside this second housing of the opening type and the contact element of this protrusion, namely the hook, locks the locking device so as to form the device which provides evidence of opening.

This device therefore appears to have two positions, one being a waiting position and the other being the armed position, and effectively makes it possible to close the container without arming the tamper-evident device before said container is filled and to arm the tamper-evident device when the container is filled.

However, such a device has many technical disadvantages even though it is a tamper-evident device which engages in a sequential manner, thus allowing the tamper-evident device, i.e. the pivoting hook with a breaking point, to operate only from the time of second opening onwards, after the arming of the tamper-evident device.

The pivoting hook is articulated about a rotation line integral with the casing, which also forms the breaking line at the time of opening the container equipped with the armed tamper-evident device. The shape of the hook is such that the slope of the end of the hook allows it to be forcefully introduced into the opening in the rim of the tab type on the lid. However, because of the undercut of the hook, it is not possible to move it out of this opening without breaking the connecting film which acts as a hinge. In the closed position of the lid and with the container empty, the hook which is to play the role of the tamper-evident device, not yet engaged, is deactivated and protected by the fact that it enters a cavity, thereby forming an angle of approximately 30° relative to the armed position.

In the open position of the lid, at the time of the injection-moulding of this one-piece container, this hook is also in this position in which it forms an angle with the axis of the container.

It is obviously difficult to guarantee the precision of this angle for this hook which may, in the course of the different manufacturing steps, no longer be at the correct angle of inclination of approximately 30° and therefore either may no longer be able to enter the waiting housing or may no longer be able to be oriented in the vertical position which allows the arming of the tamper-evident device at the time of definitive closure of the container once filled, by penetrating into the opening.

This device appears to be fragile to use in operations carried out on high-speed packaging machines, since these operations risk being disrupted by a hook positioning error. This device also appears to be complex and relatively expensive to produce since it requires a particular geometric positioning with regard to the angle in order to secure the hook in one or the other of the housings provided for this purpose.

The risk is therefore either that of a premature engagement, i.e. before the container has been filled, of the tamper-evident system which enters the incorrect housing instead of entering the correct housing at the end of manufacture of the assembly, or the impossibility of locking with the tamper-evident device at the time of definitive closure of the container. It appears that there is no certainty of absolute security with this type of device.

As can be seen, no device equipping the containers of the prior art gives satisfactory results, since these devices do not make it possible to monitor the process of arming the tamper-evident device under true industrial conditions. A stoppage of the packaging line, for example due to an incident as minor as incorrect positioning of the hook of a tamper-evident device on a container, cannot be envisaged in an industrial environment. Thus, the reliability of the devices of the prior art appears to be insufficient.

### SUMMARY OF THE INVENTION

One problem posed is that of producing a container equipped with a tamper-evident device which allows:
before filling, any closing and opening actions on the container without this tamper-evident device being engaged and without it being subjected to load, and hence destroyed, thus providing evidence that the container has been opened;
engagement of said tamper-evident device when a decision has been made to this effect, in particular once the container has been effectively filled.

Another problem posed for the designer is to overcome all or some of the disadvantages mentioned above, and thus to provide a significant improvement compared to the prior art.

The invention therefore relates to a container with tamper-evident device for packaging products, comprising:
a casing constituting the product packaging zone, closed at one of its ends by a base and open at the other,
a closure means, such as a stopper/lid, for closing the open end of the casing,
a connection means arranged between the closure means and the casing,
a tamper-evident device which is able to engage mechanically at the time of definitive closure of the container by the closure means after said container has been filled,

characterised in that said tamper-evident device consists of:
a breakable locking means, equipped with a snap-fastening means, positioned in a reserved housing located on and outside the open end of the casing, said locking means being connected to said casing via an integral tear-open hinge which keeps it rigidly in a fixed position secured to said casing,
a retaining means for retaining the snap-fastening means, said retaining means being located in the closure means receiving said snap-fastening means of the breakable locking means during the arming of the tamper-evident device,

and in that
in a non-armed state, said locking means is positioned perpendicular to the axis of symmetry of the casing within the reserved housing, being secured to said casing via the integral tear-open hinge,
in an armed state, said locking means is positioned parallel to the axis of symmetry of the casing after induced rotation about the integral tear-open hinge and is engaged in the retaining means located in the closure means in which the snap-fastening means is positioned in a definitive manner at the time of closing the casing by the closure means, thereby forming the tamper-evident device.

Another object of the invention is the use of the container for packaging products that are to be packaged, more particularly of the pharmaceutical, cosmetic, food, veterinary or diagnostic type, regardless of their physical form, solid, pasty or liquid, which may or may not be sensitive to gaseous pollutants, in particular to humidity, and require special ambient protection from the external environment.

### DETAILED DESCRIPTION OF THE INVENTION

Thus, according to the invention, the container with tamper-evident device comprises a casing constituting the product packaging zone, closed at one of its ends by a base and open at the other. This casing may have for example a tubular shape and a circular, elliptical or polygonal cross section. This casing optionally comprises an annulus or annular segment located outside the open upper end of the casing, said annulus or annular segment being arranged slightly set back with respect to the upper edge of the casing so as to allow the closure means, such as a stopper/lid, to engage in the upper lips of the open end of the casing and to allow the snap-fastening means of the breakable locking means to be snap-fastened into a retaining means of the closure means, which retaining means may be an opening. This annulus may surround the casing in a continuous manner or may be only an annular segment. When it is an annular segment, it is positioned opposite the zone in which there is located the axis of the connection means connecting the casing to its closure means.

The container with tamper-evident device according to the invention also comprises a closure means for closing the open end of the casing, which closure means may be any stopper/lid designed in such a way as to ensure leaktightness between the body of the container and the stopper/lid. This leaktightness may be provided in an architecture which combines engagement between male and female parts and matching geometric shapes, optionally making use of the elasticity of the materials constituting the casing and the closure means of the stopper/lid type.

The container with tamper-evident device according to the invention also comprises a connection means arranged between the closure means of the stopper/lid type and the casing. This connection means may be a hinge of the mechanical type with a pin or of the integral type, depending on whether the container is a two-piece container, i.e. a container consisting of a casing and a closure means of the stopper/lid type which is manufactured separately, said container therefore optionally being made from two materials which may be identical or different, or a one-piece container which is therefore generally made of a single material.

The container with tamper-evident device according to the invention finally comprises a tamper-evident device which is able to engage mechanically at the time of definitive closure of the container after said container has been filled.

This tamper-evident device consists of a breakable locking means, equipped with a snap-fastening means, positioned in a reserved housing located on and outside the open upper end of the casing, said locking means having an integral tear-open hinge on the casing. This integral tear-open hinge, because it is made of the same rigid and resilient material as the container, is able to keep the breakable locking means rigidly in a fixed position secured to said casing and positions it in its reserved housing, perpendicular to the axis of the casing.

This reserved housing of the breakable locking means constitutes, for said means, a mechanical protection which prevents premature displacement of the locking means, in a position other than the horizontal or vertical position, at the time of engagement, or prevents any risk of tearing of the locking means for example during transport or placement on industrial packaging lines.

According to a first embodiment, this reserved housing of the breakable locking means may be made in the form of a notch, in the thickness of the annulus or annular segment located outside the open upper end of the casing. In this case, said breakable locking means of the tongue/hook type is positioned in the thickness of the annulus.

According to a second embodiment, this reserved housing of the breakable locking means may consist of two parallel walls which are positioned on the casing on either side of the locking means, said walls themselves being parallel to the axis of symmetry of the casing, and the upper ends of which can form the closure stop of the closure means, such as a reclosable stopper/lid.

The two parallel walls have a depth that is at least equal to the length of the locking means and a height that is slightly smaller than the length of the locking means.

At least one vertical rib is positioned against the outer wall of the casing, in line with the integral tear-open hinge, the thickness of which rib is identical to the part of the integral tear-open hinge secured to the casing, and said rib acting as a spacer. This at least one rib makes it possible for the locking means, for example of the tongue/hook type, which tongue may have a substantially rectangular geometric shape, to be brought into the vertical position during the closure of the closure means, which may be of the stopper/lid type, and the engagement of the locking means as a result of coming into abutment against said rib.

When the reserved housing consists of the two parallel walls as mentioned above, these may also be associated with an annulus or annular segment, as described above, which may or may not level off the upper surface of said parallel walls. In this configuration, the locking means for example of the tongue/hook type is positioned below the plane of the lower face of the annulus or annular segment.

The tamper-evident device furthermore consists of a retaining means for retaining the snap-fastening means, which retaining means may be for example the aforementioned opening. This opening is located in the closure means, that is to say in the closure means of the stopper/lid type, which receives said snap-fastening means of the breakable locking means during the arming of the tamper-evident device. This opening is positioned on the immediate periphery of the closure means and in the axis of the locking means when the latter is in the armed position, that is to say in the vertical position.

In a non-armed state, said locking means according to the invention is protected by its reserved housing and is kept perpendicular to the axis of symmetry of the casing, being secured to said casing, via the integral tear-open hinge.

Thus, according to the first embodiment described above, in a non-armed state, said locking means is positioned within the housing and in the plane of the annulus or annular segment, being secured to said annulus or annular segment via the integral tear-open hinge.

In an armed state, said locking means is positioned parallel to the axis of symmetry of the casing after induced rotation about the integral tear-open hinge of said means and bears against the one or two lateral ribs, when these exist, acting as a spacer. The snap-fastening means of the locking means is then engaged in the retaining means located in the closure means, which retaining means may be an opening in which it is positioned in a definitive manner, with a non-return effect, at the time of closing the casing by the closure means, thereby forming the tamper-evident device.

The opening with a non-return effect has a polygonal, circular, semi-circular, elliptical or semi-elliptical cross section.

According to the invention, the breakable locking means, which can be released by tearing, is a tongue which is equipped with an irreversible snap-fastening means. This snap-fastening means of the breakable locking means is preferably a hook.

The breakable locking means, connected to the casing by an integral tear-open hinge, may be secured laterally to the walls of the reserved housing via at least two breakable fixing points arranged in the plane of said locking means.

The integral tear-open hinge of the locking means consists of at least two breakable articulation points or of a breakable continuous line. Preferably, the breakable hinge of the locking means consists of at least two breakable articulation points.

It comprises an end piece adjacent to the casing, on which there is positioned the at least two breakable articulation points or the breakable continuous line.

The locking means is a part belonging to the casing, that is to say integrated with the casing, body of the container, and is produced during a single injection-moulding operation.

The breakable locking means with its snap-fastening means is in a horizontal position at the time of manufacture and when it is not armed. The reserved housing provides mechanical protection and keeps the locking means horizontal before it is armed. The operations on a high-speed packaging machine therefore do not risk being disrupted by a positioning error of the locking means. The mechanical operations concerning the arming of the locking means are the upward thrust by a mechanical device specific to the packaging machine, which positions the locking means vertically by rotation about the axis formed by the at least two breakable articulation points, thus positioning the locking means in such a way that it bears vertically against the rib(s), when the latter exist.

Preferably, it should be noted that the at least two articulation points of the tongue/hook of the opening-evident means in the armed position, which will have to be broken at the time of opening the container once filled, appear to be easier to break than a hinge of the film type constituting this breakable continuous line.

Finally, with regard to moulding, the at least two breakable bridges or fixing points arranged in the plane of said locking means and the at least two articulation points form access channels for the material during the moulding of the casing, and may therefore, on account of their number, have dimensions that are easier to architecture depending on the types of plastic material used with a view to their sequenced breaking.

The casing and the closure means of the stopper/lid type are both produced using identical or different thermoplastic polymer compositions. These are thermoplastic polymer compositions which can be used alone or as a mixture.

The casing and the closure means of the stopper/lid type are thus preferably produced from an injection-moulded hard or semi-hard polymer material. Thermoforming or blow-moulding techniques may also be considered.

The polymer materials which are desired for producing the casing and the closure means of the stopper/lid type are generally and non-exclusively selected from the group of materials consisting of thermoplastic polymers, in particular comprising polyolefins such as polyethylenes, polypropylenes, ethylene/propylene copolymers and mixtures thereof, polyamides (PA), polystyrenes (PS), acrylonitrile/-butadiene/styrene (ABS) copolymers, styrene/acrylonitrile (SAN) copolymers, polymethyl methacrylates (PMMA), polyethylene terephthalates (PET), polybutylene terephthalates (PBT), polyacetals (POM), polyvinyl chlorides (PVC) and polycarbonates (PC).

At least one elastomer of natural or synthetic origin may be associated with the thermoplastic compositions from which the casing and the closure means of the stopper/lid type are produced. The elastomer(s) used may be selected from the group consisting of elastomers of the natural rubber, synthetic rubber, and in particular mono-olefin rubber type.

These are mono-olefin elastomers, such as, for example, polymers of isobutylene/isoprene, ethylene/vinyl acetate (EVA), ethylene/propylene (EPR), ethylene/propylene/diene (EPDM), ethylene/acrylic esters (EMA-EEA), fluoropolymers, diolefin rubbers, such as, for example, polybutadienes, butadiene/styrene (SBR) copolymers, rubbers based on condensation products, such as, for example, polyester and polyurethane thermoplastic rubbers, silicones, styrene rubbers, such as styrene/butadiene/styrene (SBS), styrene/isoprene/styrene (SIS), styrene/ethylene/butadiene/styrene (SEBS) and other block copolymers, used alone or as a mixture, formulated or otherwise, may also be used.

The mode of production may also be that of thermoplastic injection or extrusion and sheet cutting by any extrusion or calendering technique, followed by thermoforming or blow-moulding. Injection-moulding is selected with preference.

These containers are optionally rendered desiccative by at least one of the means which involves coating the inside of the base of the casing and/or the inner surface of the wall of the casing and/or of the stopper/lid by means of a desiccative thermoplastic polymer composition, introducing an insert into said casing, and/or introducing a desiccative material arranged in a special housing on the inner surface of the casing and/or the stopper/lid.

All these desiccative means are installed separately or simultaneously in order to increase the effectiveness of their dehydrating action by a mass effect.

Thus, these containers may comprise a dehydrating agent which makes it possible to modify the internal atmosphere of said container once closed.

The sequence for producing and using the packaging proposed according to the invention is in the form of the step-by-step method comprising:

a) separate injection of the casing and of the closure means, which is a stopper/lid, by the packaging manufacturer, or, according to a variant, simultaneous injection of the casing and of the closure means with an integral hinge according to a single-material concept,

b) optionally introduction of an ambient air treatment agent by the packaging manufacturer, for example filling of the stopper/lid with a dehydrating agent or an agent for adsorbing gaseous elements which pollute the internal atmosphere of the container,

c) assembly of the casing and of the closure means with or without closure of said closure means at the packaging manufacturer's premises in the case of two separate components consisting of the casing and closure means of the stopper/lid type, so as to obtain a sealed and protected unit or simple closure in the case of a single-piece unit optionally with an integral hinge,

d) delivery of the container with tamper-evident device to the packager, for example a pharmaceutical laboratory,

e) supplying of the container and products to the filling machine and opening of the closure means, such as a stopper/lid, of said container directly on the filling line,

f) filling of the container with products,

g) arming of the tamper-evident device by breaking the breakable points by any mechanical means actuated so as to pass from a non-armed position to the armed position of the snap-fastening means in the reserved opening of the closure means, that is to say of the closure means after filling,

h) closure of the closure means after filling,

i) placement of the filled tamper-proof container on the market,

j) breaking of the tamper-evident device by the end user at the time of first opening.

The invention will be better understood by virtue of the following description of the figures including reference numbers, said figures being purely illustrative and non-limiting in nature and showing one particular desiccative container of the invention.

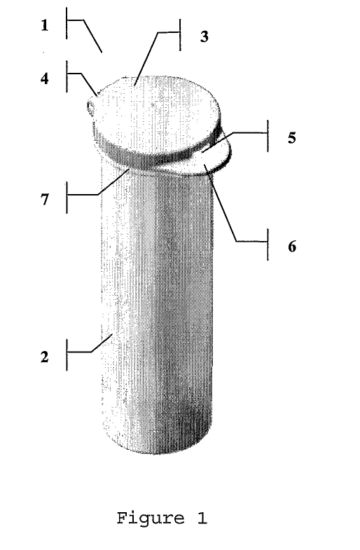

FIG. 1 shows a perspective view of a container equipped with its opening-evident means in the closed position;

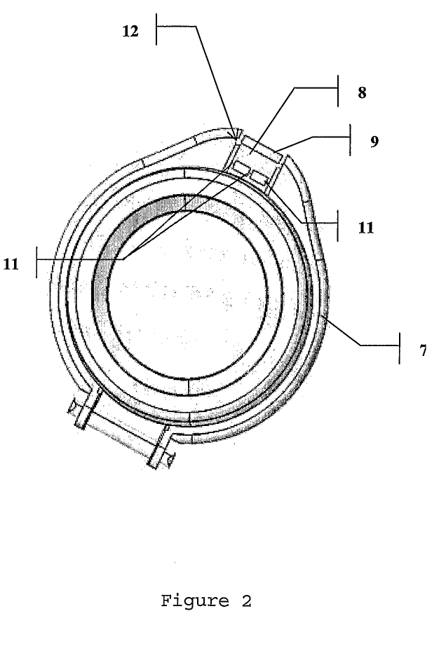

FIG. 2 shows a view from below of the container according to the invention, which makes it possible to see the breakable locking means arranged in its housing in the non-armed position;

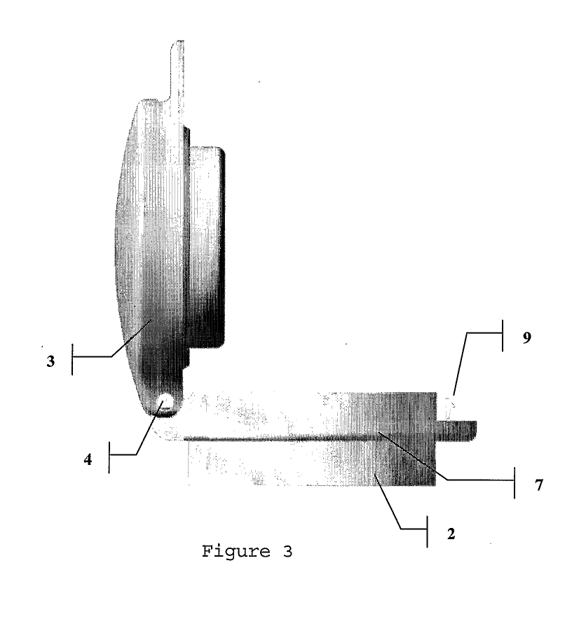

FIG. 3 shows a profile view of the top part of the casing of the container and of the associated stopper/lid and of the breakable locking means arranged in its housing in the armed position prior to closure of the casing after filling;

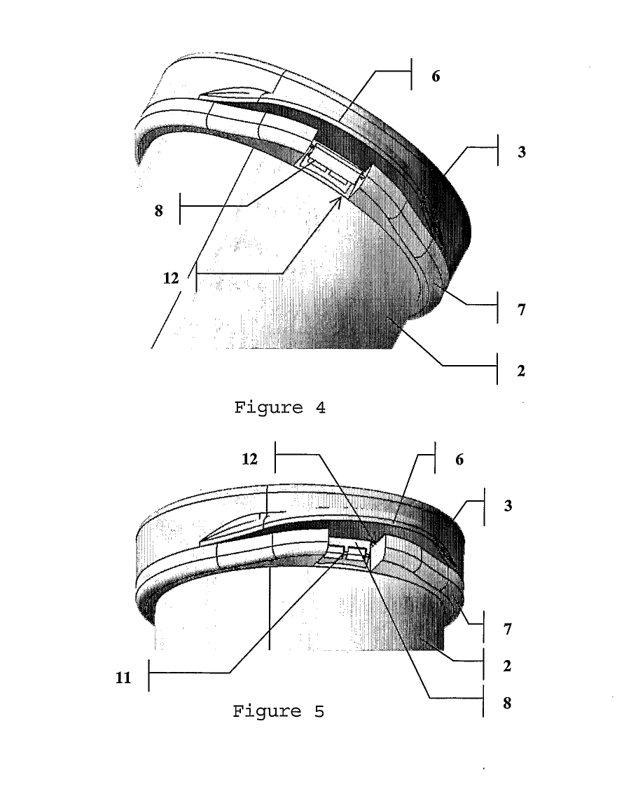

FIG. 4 shows an oblique perspective view from below of the top part of the casing of the container and of the closed stopper/lid with its breakable locking means arranged in its housing in the non-armed position;

FIG. 5 shows an oblique perspective view from below of the top part of the casing of the container and of the closed stopper/lid with its breakable locking means arranged in its housing in the armed position;

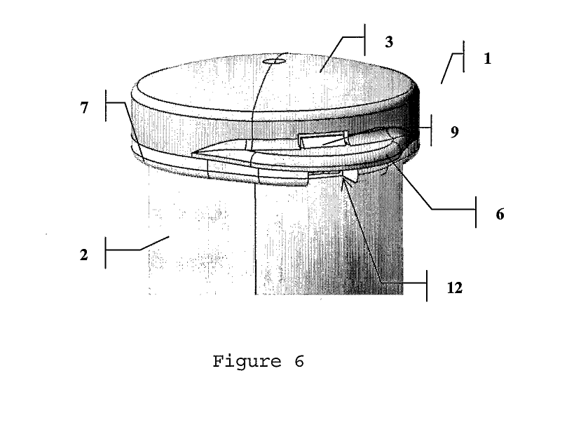

FIG. 6 shows an oblique perspective view from above of the top part of the casing of the container and of the closed stopper/lid with its breakable locking means arranged in its housing in the armed position and showing the visible part of the snap-fastening means, that is to say the upper part of the hook constituting the tamper-evident device;

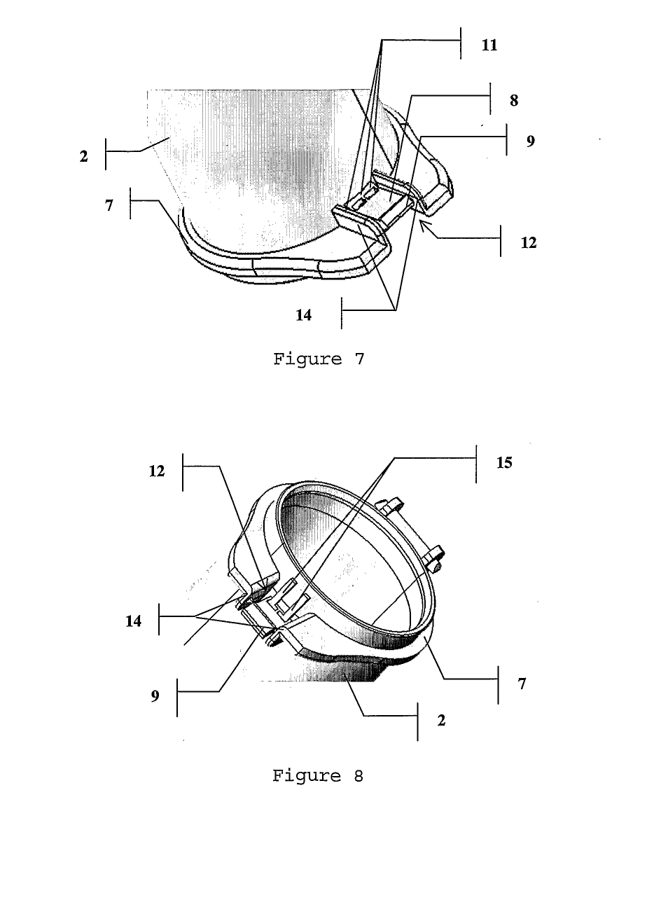

FIG. 7 shows an oblique perspective view from below of the top part of the casing, showing the protective housing of the locking means and the non-armed locking means;

FIG. 8 shows an oblique perspective view from above of the top part of the casing, showing the protective housing of the locking means and the non-armed locking means;

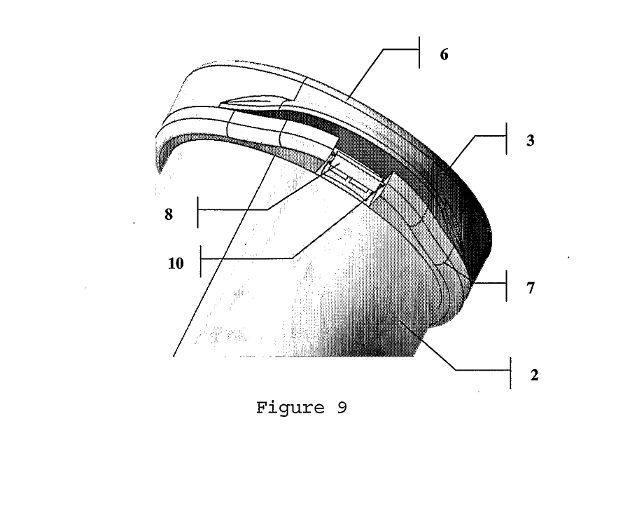

FIG. 9 shows an oblique perspective view from below of the top part of the casing of the container and of the closed stopper/lid with its breakable locking means in the armed position.

FIG. 1 shows a perspective view of the container (1) according to the invention. This container consists of the casing (2), its closure means (3) which is a stopper/lid equipped with a connection means (4) between the closure means and the casing, and which is a hinge, and of the tamper-evident device (5). The stopper/lid (3) has a rim forming a tab (6). The casing (2) is equipped with an annulus (7).

This container (1) is in the closed position after filling, with the tamper-evident device armed.

FIG. 2, which is a view of the container (1) from below, makes it possible to show the details of the breakable locking means (8).

This breakable locking means (8) is equipped with the snap-fastening means (9), positioned in a reserved housing (12) in the annulus (7) located outside the open upper end of the casing. This locking means (8) has an integral tear-open hinge (11) connecting it to the annulus (7). This integral tear-open hinge (11) keeps the breakable locking means (8) in a fixed position secured to the casing and positions it in its housing (12), perpendicular to the axis of the casing (2).

FIG. 3 shows a profile view of the top part of the casing (2) of the container (1) and of the associated stopper/lid (3) and of the breakable locking means (8) in the armed position prior to closing the casing after filling. The snap-fastening means of the hook type (9) is in the armed position while waiting for the closure of the filled container (1).

FIG. 4 shows an oblique perspective view from below of the top part of the casing (2) of the container (1) and of the closed stopper/lid (3) with its breakable locking means (8) in the non-armed position.

FIG. 5 shows an oblique perspective view from below of the top part of the casing (2) of the container (1) and of the closed stopper/lid (3) with its breakable locking means (8) in the armed position.

FIG. 6 shows an oblique perspective view from above of the top part of the casing (2) of the container (1) and of the closed stopper/lid (3) with its breakable locking means (8) in the armed position and showing the visible part of the snap-fastening means (9), that is to say the upper part of the hook constituting the tamper-evident device. This tongue/hook (8, 9) is positioned in the thickness of the annulus.

FIG. 7 shows an oblique perspective view from below of the top part of the casing (2) of the container (1). The reserved housing (12) formed by the two spaced-apart parallel walls (14) fixed to the casing and bearing against the annulus protects the tongue/hook of the locking means (8) and of the snap-fastening means (9). This tongue/hook (8, 9) is positioned below the annulus. The tongue/hook remains perpendicular to the axis of symmetry of the casing during removal from the mould and prior to arming at the time of definitive closure of the container.

FIG. 8 shows an oblique perspective view from above of the top part of the casing (2) of the container 1.

The reserved housing (12) formed by the two spaced-apart walls (14) fixed to the casing and bearing against the annulus protects the tongue/hook (8, 9) of the locking means.

This tongue/hook (8, 9) is positioned in a plane which is different from the plane of the annulus but parallel to this plane and set back relative thereto.

The two tongues forming spacers (15) allow the bearing of the tongue/hook and its vertical position parallel to the axis of the container at the time of arming of the locking means.

FIG. 9, which is an oblique perspective view from below of the top part of the casing of the container and of the closed stopper/lid with its breakable locking means in the armed position, makes it possible to show the breakable fixing points (10).

1. Container with tamper-evident device (1) for packaging products, comprising:
a casing (2) constituting the product packaging zone, closed at one of its ends by a base and open at the other,
a closure means (3), such as a stopper/lid, for closing the open end of the casing,
a connection means (4) arranged between the closure means (3) and the casing (2),
a tamper-evident device (5) which is able to engage mechanically at the time of definitive closure of the container by the closure means after said container has been filled,
said tamper-evident device (5) comprising:
a breakable locking means (8), equipped with a snap-fastening means (9), positioned in a reserved housing (12) located on and outside the open end of the casing (2), said locking means (8) being connected to said casing (2) via an integral tear-open hinge (11) which keeps it rigidly in a fixed position secured to said casing (2),
a retaining means for retaining the snap-fastening means (9), said retaining means being located in the closure means (3) receiving said snap-fastening means (9) of the breakable locking means (8) during the arming of the tamper-evident device (5), and
in a non-armed state, said locking means (8) is positioned perpendicular to the axis of symmetry of the casing (2) within the reserved housing (12), being secured to said casing (2) via the integral tear-open hinge (11),
in an armed state, said locking means (8) is positioned parallel to the axis of symmetry of the casing (2) after induced rotation about the integral tear-open hinge (11) and is engaged in the retaining means located in the closure means (3) in which the snap-fastening means (9) is positioned in a definitive manner at the time of closing the casing (2) by the closure means (3), thereby forming the tamper-evident device.

2. Container with tamper-evident device (1) according to claim 1, characterised in that the breakable locking means (8), which can be released by tearing, is a tongue which is equipped with an irreversible snap-fastening means (9).

3. Container with tamper-evident device according to claim 2, characterised in that the snap-fastening means (9) of the breakable locking means (8) is a hook.

4. Container with tamper-evident device (1) according to claim 1, characterised in that the retaining means of the snap-fastening means (9) located in the closure means (3) is an opening.

5. Container with tamper-evident device (1) according to claim 4, characterised in that the opening in the closure means has a polygonal, circular, semi-circular, elliptical or semi-elliptical cross section.

6. Container with tamper-evident device (1) according to claim 1, characterised in that the breakable locking means (8), connected to the casing (2) by an integral tear-open hinge (11), is secured laterally to the walls of the reserved housing (12) via at least two breakable fixing points (10) arranged in the plane of said locking means (8).

7. Container with tamper-evident device (1) according to claim 1, characterised in that the reserved housing (12) for said breakable locking means (8) is situated in an annulus or annular segment (7) located outside the open upper end of the casing (2), said annulus or annular segment being arranged slightly set back with respect to the upper edge of said casing (2).

8. Container with tamper-evident device (1) according to claim 1, characterised in that the reserved housing (12) of said breakable locking means (8) consists of two parallel walls (14) which are positioned on the casing (2) on either side of the locking means (8), said walls themselves being parallel to the axis of symmetry of the casing (2).

9. Container with tamper-evident device (1) according to claim 8, characterised in that the upper ends of the two parallel walls (14) constitute the closure stop of the closure means, such as a reclosable stopper/lid (3).

10. Container with tamper-evident device (1) according to claim 8, characterised in that the two parallel walls (14) of the reserved housing (12) of the breakable locking means (8) have a depth that is at least equal to the length of the locking means (8) and a height that is slightly smaller than the length of the locking means (8).

11. Container with tamper-evident device (1) according to claim 1, characterised in that the reserved housing (12) of the locking means (8) consists of the combination of two parallel walls (14) and an annulus or annular segment (7).

12. Container with tamper-evident device (1) according to claim 1, characterised in that the integral tear-open hinge (11) of the locking means (8) consists of at least two breakable articulation points.

13. Container with tamper-evident device (1) according to claim 1, characterised in that the integral tear-open hinge (11) of the locking means (8) consists of a breakable continuous line.

14. Container with tamper-evident device (1) according to claim 1, characterised in that the container (1) comprises a dehydrating agent which makes it possible to modify the internal atmosphere of said container once closed.

15. Container with tamper-evident device (1) according to claim 1, characterised in that the connection means (4) arranged between the closure means (3) and the casing (2) is a hinge of the integral type (11) or of the mechanical type with a pin.

16. Container with tamper-evident device (1) according to claim 1, characterised in that the casing (2) and the closure means (3) are both produced using identical or different thermoplastic polymer compositions.

17. Container with tamper-evident device (1) according to claim 1, characterised in that the casing (2) and the closure means (3) are produced by plastic processing methods using thermoplastic polymer compositions selected from the group consisting of polyethylenes (PE), polypropylenes (PP), ethylene/propylene copolymers and mixtures thereof, polyamides (PA), polystyrenes (PS), acrylonitrile/butadiene/styrene (ABS) copolymers, styrene/-acrylonitrile (SAN) copolymers, polyvinyl chlorides (PVC), polycarbonates (PC), polymethyl methacrylates (PMMA), polyethylene terephthalates (PET), used alone or as a mixture.

18. Container with tamper-evident device (1) according to claim 17, characterised in that at least one elastomer of natural or synthetic origin is associated with the thermoplastic compositions, the elastomer(s) used being selected from the group consisting of elastomers of the following types: natural rubbers, synthetic rubber, in particular mono-olefin rubbers, which are polymers of isobutylene/isoprene, ethylene/vinyl acetate (EVA), ethylene/propylene (EPR), ethylene/propylene/diene (EPDM), ethylene/acrylic esters (EMA-EEA), fluoropolymers, diolefin rubbers, which are polybutadienes, butadiene/styrene (SBR) copolymers, rubbers based on condensation products which are polyester and polyurethane thermoplastic rubbers, silicones, styrene rubbers which are styrene/butadiene/styrene (SBS) and styrene/isoprene/styrene (SIS).

19. Method for producing and using a container with tamper-evident device (1) according to claim 1, comprising the steps of:
a) injection of the casing (2) and of the closure means (3) by the packaging manufacturer,
b) optionally introduction of an ambient air treatment agent by the packaging manufacturer,
c) assembly of the casing (2) and of the closure means (3) with or without closure of said closure means (3) at the packaging manufacturer's premises,
d) delivery of the container with tamper-evident device (1) to the packager,
e) supplying of the container (1) and products to the filling machine and opening of the closure means (3) of said container (1) directly on the filling line,
f) filling of the container (1) with products,
g) arming of the tamper-evident device (5) by breaking the breakable points (10) by any mechanical means actuated so as to pass from a non-armed position to the armed position of the snap-fastening means (9) in the reserved opening of the closure means (3),
h) closure of the closure means (3) after filling,
i) placement of the filled container (1) on the market,
j) breaking of the tamper-evident device (5) by the end user at the time of first opening.

20. (canceled)
